(19) United States
(12) Patent Application Publication
(10) Pub. No.: US 2005/0198892 A1
(43) Pub. Date: Sep. 15, 2005

(54) Underwater trap structure

(76) Inventor: Jun Hui Lin, Tainan City (TW)

Correspondence Address: LIN Jun Hui, PO Box 82-144, Taipei, TW

(21) Appl. No.: 10/796,087

(22) Filed: Mar. 10, 2004

(51) Int. Cl. A01K 69/06; A01M 23/08

(52) U.S. Cl. 43/100; 43/66; 43/65

(57) ABSTRACT

An improved underwater trap structure is disclosed. The trap structure is easily assembled and conveniently disassembling, and facilitates the trapping of fishes and crabs. The trap structure can sink down to the bottom of waters without being hooked. The trap structure has a trapping cylinder having a handle positioned at the center of the cylinder, and an entrance at the front portion of the trapping cylinder. The entrance is positioned with a rubber funnel having a front grip which is fastened using a front mount. The rear section of the trapping cylinder is mounted with a securing hole and a bait cylinder for holding bait is placed which is secured by a rear cover.

### BACKGROUND OF THE INVENTION

(a) Technical Field of the Invention

The present invention relates to trap structure, and in particular, to trap structure used in underwater, which can be easily and conveniently assembling and disassembling. The trap structure will not be easily hooked to the bottom of waters. The handle of the trapping cylinder is tied with a float to indicate the sinking position of the trap. The front portion of the entrance of the trapping cylinder is a rubber funnel so that larger size fishes and crabs shall not be able to escape from the trap. The rear securing hole is provided with a bait cylinder which allows rapid changing of bait.

(b) Description of the Prior Art

FIG. 1 is a perspective view of a conventional fish trap having a netting 10 of any shape forming into a cavity. Normally a rotten fish head or the like is provided within the cavity to attract crab X. FIG. 2 is a perspective view of another conventional fish trap having a trapping netting 20 extended by framing robs 201 underwater. Ropes are used to tie the ropes 201, and the fish head is tied using rope 202 above the netting 20. Both the conventional fish trap employ netting and trapping net 201 to entangle the legs of crabs X. However, other marine fish cannot be caught. Further, small fishes shall never be caught, and it is often that the netting is entangled and cannot be retrieved. The drawbacks of such conventional trap structure are that the trap is easily entangled by corals or other rocks at the seal, and the rotten fish heads A is a pollution to the waters. Moreover, when a trapped crab is caught, it is not easily unloaded for the reasons that the entangled legs of the crab may be broken in the course of removal of the crabs. Accordingly, it is an object of the present invention to provide an improved structure of a trap for use underwater.

### SUMMARY OF THE INVENTION

An object of the present invention is to provide an improved structure of a trap characterized in that a trapping cylinder is formed from netting and a handle is provided at the top portion of the center region of the trapping cylinder for holding and tying to a positioning float; the trapping cylinder has a front entrance with a front grip at the front portion of the trapping cylinder, and in the front entrance a rubber funnel having a rubber grip is provided which is extendable and contractable to prevent fish or crab from escaping away from the trapping cylinder, and a front mount is used to fasten the front grip and rubber grip, and the rear portion of the trapping cylinder is a securing hole provided with bait, which is covered by a rear cover.

Yet another object of the present invention is to provide an improved structure of a trap, wherein a rubber funnel provided with a plurality of threads arranged radially is provided at the front portion of the trapping cylinder.

Yet another object of the present invention is to provide an improved structure of a trap for used in underwater, wherein the structure can be easily and conveniently assembling and disassembling and can be sunk to the bottom of the waters without being entangled. Fishes and crabs easily enter the trap without escaping and big fishes and crabs can be trapped.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view of a conventional fish trap structure.

FIG. 2 is a perspective view of another conventional fish trap structure.

FIG. 3 is an exploded perspective view of the trap structure in accordance with the present invention.

FIG. 4 is a sectional view of the trap structure in accordance with the present invention.

FIG. 5 is a schematic view showing the trap structure sunk underwater in accordance with the present invention.

FIG. 6 is a schematic view showing the trapping of fish and crab in accordance with the present invention.

FIG. 7 is another schematic view showing the trapping of fish and crab in accordance with the present invention.

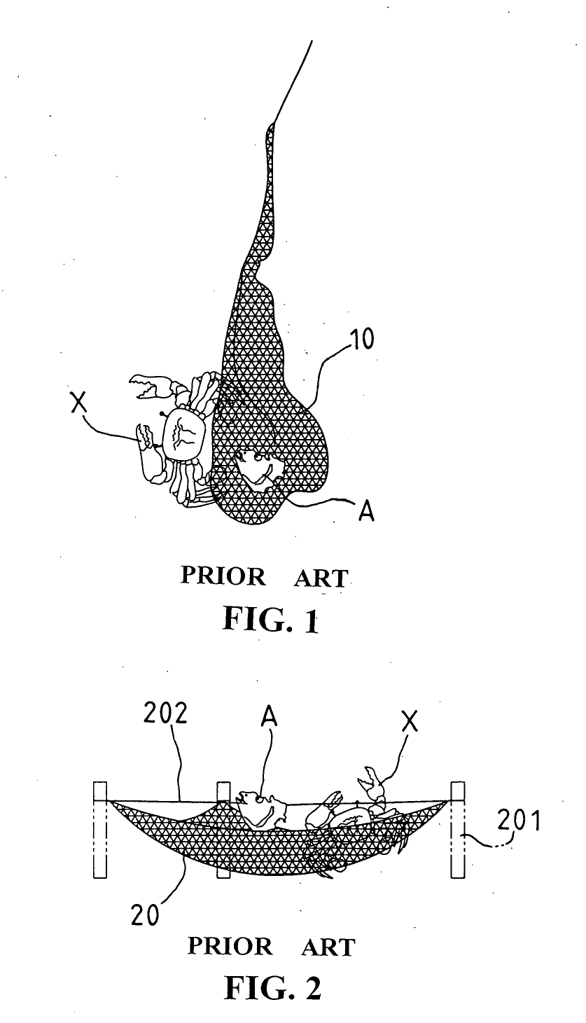

### DETAILED DESCRIPTION OF THE PREFERRED EMBODIMENTS

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

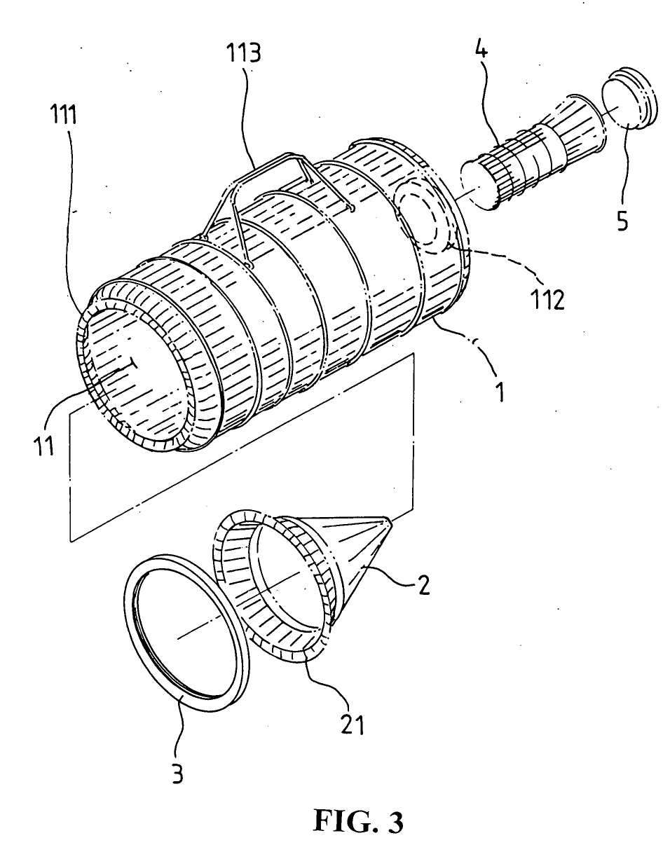

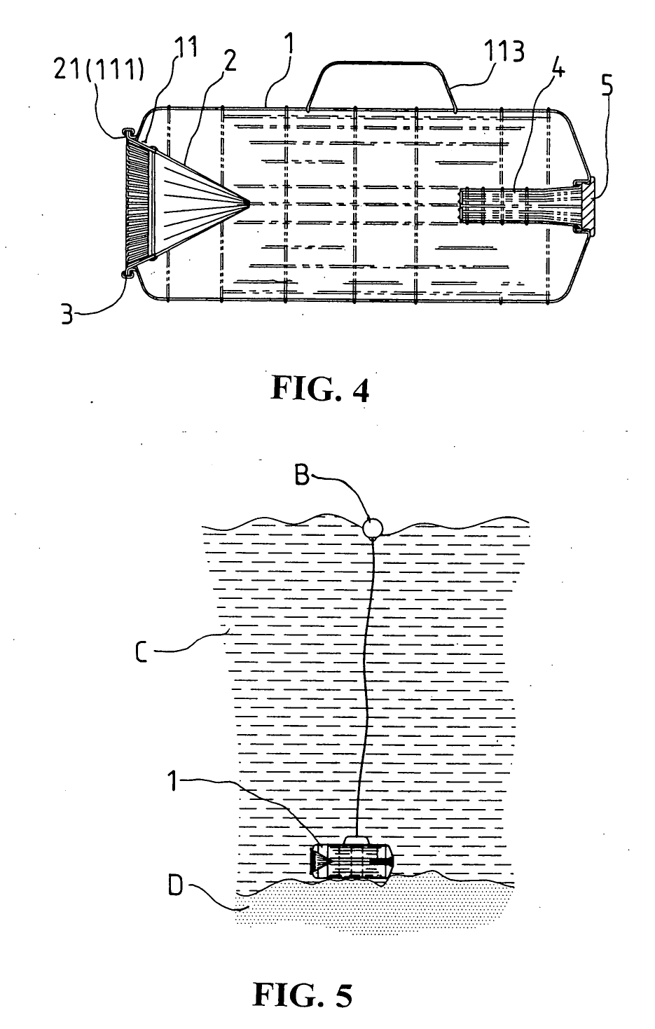

Referring to FIGS. 3 and 4, there is shown the improved structure of a trap having a trapping cylinder 1 formed from netting. The front and the rear portion of the trapping cylinder 1 are provided with a tapered entrance. The front portion is a front entrance 11, and the end portion of the front entrance 11 is provided with a front grip 111. The interior of the front entrance 11 is mounted with a conic shape or other shape rubber funnel 12 having a rubber funnel front grip 21. A front mount 3 having an inverted U-shaped is used to fasten a front grip 111 and a rubber funnel front grip 21 as a unit. The top portion at the center of the trapping cylinder 1 is provided with a handle 13 for holding and for typing to a float (as shown in FIG. 3). The rear portion of the trapping cylinder 1 is a securing hole 112 which can be mounted with a bait cylinder 4 formed from netting. A rear cover 5 is used for the covering of the securing hole 112.

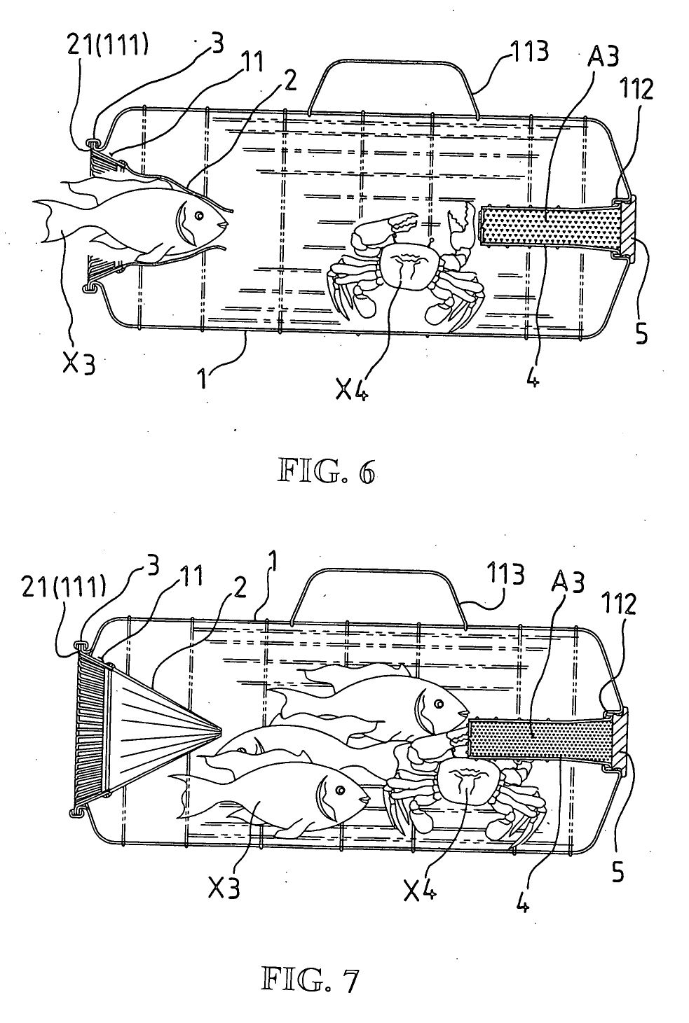

The trap structure is made from metallic material and due to its weight, the trap structure (the trapping cylinder 1) will automatically sink to the bottom D of the waters, as shown in FIG. 5. In order to indicate the position of the trap and to ensure all the traps are being retrieved the handle 113 is tied to a float B and the float B is floating above the water surface C. Therefore the trap structure can be pulled out from the water. The rubber funnel 2 is positioned at the front entrance 11 and is tapered. In order to provide fastening of the front grip 111 at the front portion of the trapping cylinder 1, the front portion of the rubber funnel 2 is provided with a rubber funnel front grip 21. By employing the front mount 3, the two components are secured together as one unit. Accordingly, when a fish X3 enters via the rubber funnel 2 having a plurality of radially arranged threads, the fish can swim in smoothly in accordance with the funnel 2. The funnel 2 can be easily extended and the large fish X3 can easily swim into the trapping cylinder, as shown in FIG. 6.

After the fish X3 is within the trapping cylinder 1, the rear end of the rubber funnel 2 is contracted and the fish cannot be escaped from the funnel 2. That is the fish X3 shall be trapped within the trapping cylinder 1. Similarly, big crabs X4 are also being trapped. The bait A3 at the bait cylinder attract fishes and crabs will not pollute the waters. Further, the trapping cylinder 1 will not hook to the bottom D of the water. As shown in FIG. 7, those trapped fish X3, crab X4 cannot be escaped. As the space of the trapping cylinder 1 is larger enough the trapped fish or crab is normally alive and is of good quality.

In order to retrieve the trapping cylinder 1, the float, as shown in FIG. 5, is located and the trapping cylinder 1 is pulled above the water. The front mount 3 is unloaded and the rubber funnel 2 can be withdrawn from the entrance 11, and the catch (fish X3, crab X4) can be taken out via the front entrance 11. If the bait A3 is to be refilled, the rear cover 5 is opened, and the bait cylinder 4 is unloaded.

While the invention has been described with respect to preferred embodiments, it will be clear to those skilled in the art that modifications and improvements may be made to the invention without departing from the spirit and scope of the invention. Therefore, the invention is not to be limited by the specific illustrative embodiment, but only by the scope of the appended claims.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

1-3. (canceled)

4. An improved structure of a trap wherein a trapping cylinder is Formed from netting and a handle is provided at a top portion of a center region of the trapping cylinder for holding and being tied to a positioning float; the trapping cylinder has a front entrance with a front grip at a front portion of the trapping cylinder, and a rubber funnel having a rubber grip which is extendable and contractable is provided in the front entrance to prevent a fish or crab from escaping away from the trapping cylinder, and a front mount is used to fasten the front grip and rubber grip, and a rear portion of the trapping cylinder has a securing hole provided with bait, which is covered by a rear cover, the rubber funnel has a conical shape, and the rubber funnel is provided with a plurality of threads in a radial direction.
